(19) United States
(12) Patent Application Publication
(10) Pub. No.: US 2010/0218213 A1
(43) Pub. Date: Aug. 26, 2010

(54) CONTROL USER INTERFACE DELIVERY METHOD AND APPARATUS IN DIGITAL BROADCAST SYSTEM

(75) Inventors: Ho Yeon PARK, Seoul (KR); Ji Eun Keum, Suwon-si (KR); Jun Hyung Kim, Suwon-si (KR); Sung Oh Hwang, Yongin-si (KR); Bo Sun Jung, Seongnam-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/712,815

(22) Filed: Feb. 25, 2010

(30) Foreign Application Priority Data
Feb. 25, 2009 (KR) 10-2009-0015708

(51) Int. Cl. H04N 5/445

(52) U.S. Cl. 725/40

(57) ABSTRACT

A method and apparatus for delivering a Control User Interface (CUI) using an Electronic Program Guide (EPG) is provided for a broadcast system. A transmission apparatus for a digital broadcast system includes a provider that provides one or more of services and content. The apparatus also includes an information generator that generates EPG information including CUI information. The apparatus further includes a transmitter that transmits the EPG information and the one or more of the services and content. The CUI information is provided per service and per content.

### PRIORITY

This application claims priority under 35 U.S.C. §119(a) to an application filed in the Korean Intellectual Property Office on Feb. 25, 2009, and assigned Serial No. 10-2009-0015708, the content of which is incorporated herein by reference.

### BACKGROUND OF THE INVENTION

1. Field of the Invention

The present invention relates generally to a broadcast system and, more particularly, to a method and apparatus for delivering a Control User Interface (CUI) using an Electronic Program Guide (EPG) in a broadcast system.

2. Description of the Related Art

As IP-based technologies converge and wired and wireless communication are integrated, integrated communication and broadcast services are emerging as new business models with promising marketability. One example of communication and broadcast integration is Internet Protocol Television (IPTV) technology, which provides an integration of conventional TV, voice, and data technologies. IPTV technology also supports user interactivity, thereby providing opportunities for various business models and services. Particularly, the IPTV technology provides both fixed terminals (such as set-top boxes, Personal Computers (PCs), and television sets) and mobile devices (such as mobile phones, Personal Digital Assistants (PDAs), and laptop computers) with flexible communication and broadcast services in any environment using wired, wireless, and broadcast networks. The IPTV technology can be exploited to create diverse types of services in consideration of the various network environments.

FIG. 1 is a schematic diagram illustrating a unified remote CUI system for controlling different types of contents. FIG. 2 is a diagram illustrating buttons for controlling playback of Content on Demand (CoD) on the unified remote CUI system of FIG. 1. FIG. 3 is a diagram illustrating buttons for inputting alphanumeric characters on the unified remote CUI system of FIG. 1.

Referring to FIGS. 1 to 3, real time broadcast content 101 does not support a play button 201, a pause button 202, a stop button 203, a fast reverse button 200, and fast forward button 204. This is because the real time broadcast content is transmitted in the form of a stream. All of the playback control buttons shown in FIG. 2 are supported for CoD content 102. Unlike the real time broadcast content 101, the CoD content 102 can be stored so as to be controlled with the play button 201, the fast reverse button 200, the fast forward button 204, and the pause button 202 provided by a remote controller. However, there is no need for the CoD content 102 to support the alphanumeric character buttons 300 and 301 as shown in FIG. 3.

Typically, in integrated communication and broadcast systems the real time broadcast content can be played by a communication device, and the contents downloaded through the communication system can be played by a broadcast receiver. In order for a user to be provided with both the broadcast and file contents, the mobile device is configured to provide the user with a CUI that adapts to the type of contents to be played. Thus, the services/contents provider may need to provide the user with the CUI information adaptive to the type of contents, along with the corresponding contents, i.e., the real time broadcast content 101, the CoD content 102, chatting content 103, and other contents 104.

### SUMMARY OF THE INVENTION

The present invention has been made to address at least the above problems and/or disadvantages and to provide at least the advantages described below. Accordingly, an aspect of the present invention provides a CUI processing method and device that is capable of providing a user with a content-specific CUI using an EPG that is transmitted from the service/contents provider to the end user device.

According to one aspect of the present invention, a transmission apparatus for a digital broadcast system is provided. The apparatus includes a provider that provides one or more of services and contents, an information generator that generates EPG information including CUI information, and a transmitter that transmits the EPG information and the one or more of the contents. The CUI information is provided per service and per contents.

According to another aspect of the present invention, a reception apparatus for a digital broadcast system is provided. The apparatus includes a receiver which receives one or more of services and contents and EPG information including CUI information. The apparatus also includes a renderer that renders an EPG and the one or more of the services and contents and builds a CUI of a selected service or contents based on the CUI information extracted from the EPG information. The apparatus further includes a controller that controls display of the CUI of the selected service or contents and playback of the selected service or contents in response to a command input by means of the CUI.

According to a further aspect of the present invention, a digital broadcast system is provided. The system includes a transmitter having a provider that provides one or more of services and contents, an information generator that generates EPG information including CUI information, and a transmitter that transmits the EPG information and the one or more of the services and contents. The system also includes a receiver having a receiving unit that receives the one or more of the services and contents and the EPG information including the CUI information, a renderer that renders the EPG and the one or more of the services and contents and builds a CUI of a selected service or contents based on the CUI information extracted from the EPG information, and a controller that controls display of the CUI of the selected service or contents and playback of the selected service or contents in response to a command input by means of the CUI. The CUI information is provided per service and per contents.

According to an additional aspect of the present invention, a service/contents delivery method for a digital broadcast system is provided. CUI information for controlling consumption of one or more of services and contents is generated at a transmitter. EPG information including items representing the one or more of the services and contents and the CUI information is generated. The EPG information and the one or more of the services and contents are transmitted. The CUI information is provided per service and per contents.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a schematic diagram illustrating a unified remote CUI system for controlling different types of content;

FIG. 2 is a diagram illustrating buttons for controlling playback of CoD on the unified remote CUI system of FIG. 1;

FIG. 3 is a diagram illustrating buttons for inputting alphanumeric characters on the unified remote CUI system of FIG. 1;

FIG. 4 is a diagram illustrating a digital broadcast system for delivering content-specific CUI, according to an embodiment of the present invention;

FIG. 5 is a diagram illustrating a digital broadcast system for delivering content-specific CUI, according to another embodiment of the present invention;

FIG. 6 is a diagram illustrating a CUI delivered in an EPG for use in a digital broadcast system, according to an embodiment of the present invention;

FIG. 7 is a diagram illustrating a metadata type structure for carrying the EPG and the CUI of FIG. 6, according to an embodiment of the present invention;

FIG. 8 is a diagram illustrating a metadata structure for providing a content-specific CUI, according to an embodiment of the present invention;

FIG. 9 is a sequence diagram illustrating operations of a controller, an Operator Interface (OITF) device, and an IPTV service provider constituting a digital broadcast system for supporting the CUI delivery method, according to an embodiment of the present invention;

FIG. 10 is a sequence diagram illustrating operations of a controller, an Operator Interface/Application Gateway (OITF/AG), and an IPTV service provider constituting a digital broadcast system for supporting the CUI delivery method, according to another embodiment of the present invention;

FIG. 11 is a sequence diagram illustrating operations a controller, an OITF/AG, and an IPTV service provider constituting a digital broadcast system when the Enhanced-Broadband Content Guide (E-BCG) metadata is updated while consuming content, according to an embodiment of the present invention; and

FIG. 12 is a diagram illustrating a structure of KeyCode group, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be by the same or similar reference numerals although they are illustrated in different drawings. Detailed descriptions of constructions or processes known in the art may be omitted to avoid obscuring the subject matter of the present invention.

In an embodiment of the present invention, a description is made of a converged communication and broadcast system in which a service/content provider provides content-specific CUI information in an EPG such that a user device processes the CUI information to provide the user with the content type-CUI. The term “EPG” can be replaced by other terms depending on IPTV broadcast technology. For example, the term “EPG” can be replaced by an Electronic Service Guide (ESG) for use in the Digital Video Broadcasting (DVB) system. In the following description, the term “EPG” is used to represent all the types of digital guides that provide the user with program information and system information used in the IPTV system.

In an embodiment of the present invention, a description is made of methods and procedures for defining content-specific CUI information in the EPG, defining a relationship between the content (program) and corresponding CUI information, receiving the EPG and processing the CUI information carried by the EPG at the user device, creating the CUI based on the CUI information extracted from the EPG, and supplying the created CUI to a controller.

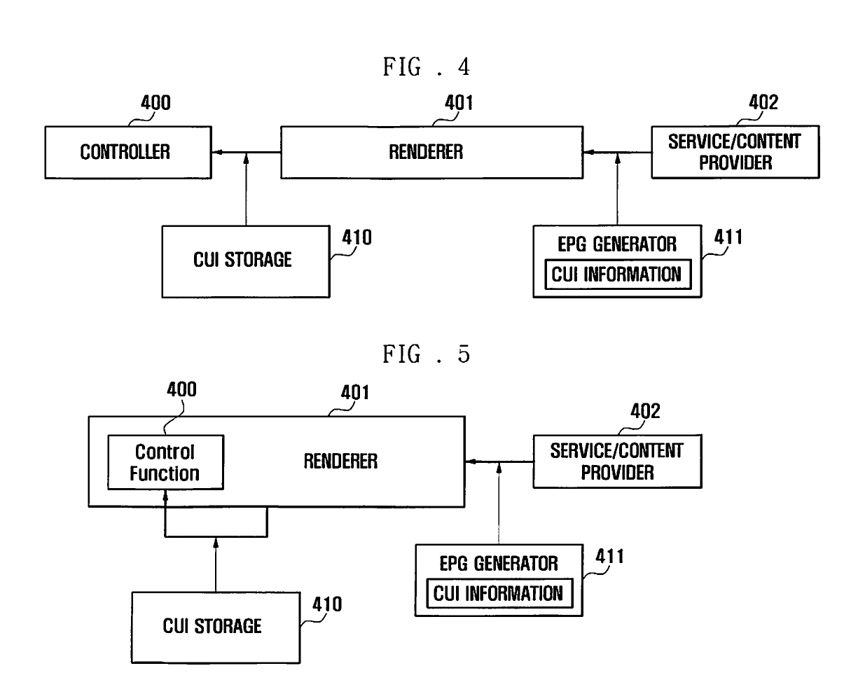

FIG. 4 is a diagram illustrating a digital broadcast system for delivering content-specific CUI, according to an embodiment of the present invention.

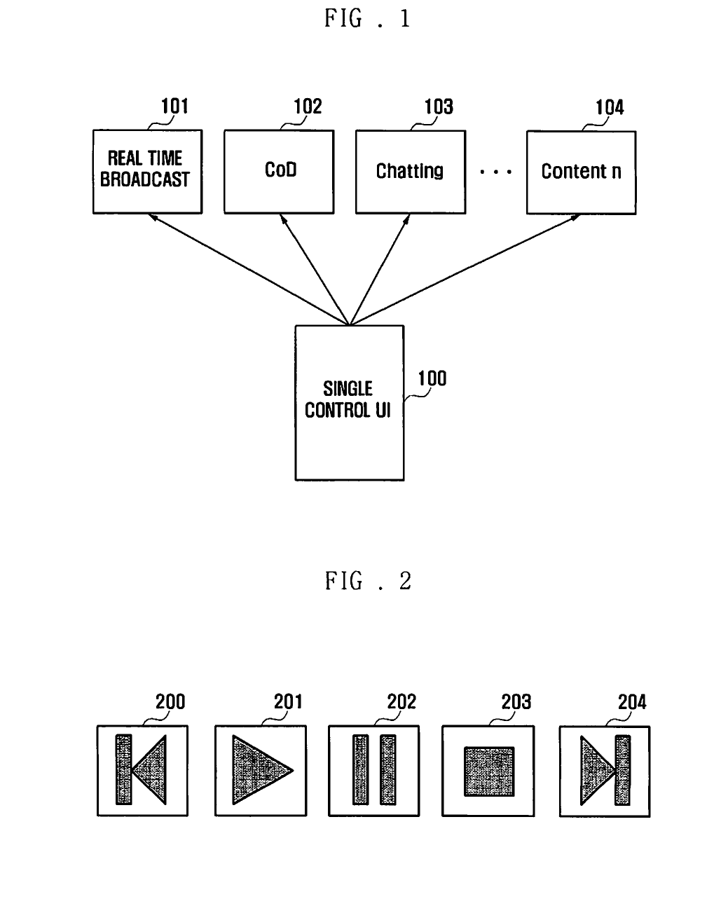

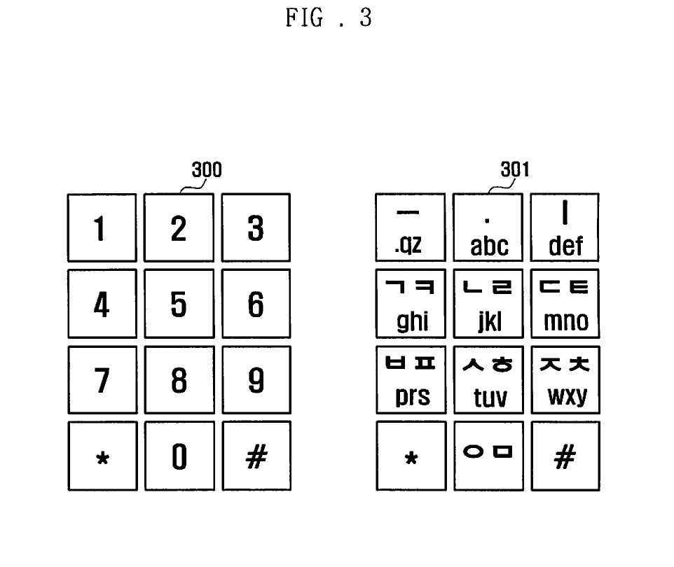

Referring to FIG. 4, a service/content provider 402 provides services and contents. The services and contents may include the real time broadcast content 101, the CoD content 102, the chatting content 103, and the other content 104, as shown in FIG. 1. An EPG generator 411 generates EPG information including CUI information corresponding to the corresponding services and contents. The EPG is a format for providing users with information such as system information related to the digital broadcast system and program information related to the programs broadcasted in the digital broadcast system. The EPG information includes the CUI information defined according to an embodiment of the present invention. The CUI information allows the user device to create the CUI for the user to control the playback of the content. For example, a CoD-specific CUI can be configured with the playback control buttons as shown in FIG. 2, but not the alphanumeric character buttons of FIG. 3. A broadcast-specific CUI can be configured with the alphanumeric character buttons of FIG. 3 but not the playback control buttons of FIG. 2. The EPG containing service/contents information and the CUI is delivered to the user devices.

The service/content provider 402 and the EPG generator 411 are the function blocks of a transmission part, i.e., the digital broadcast station of a digital broadcast system.

A renderer 401 receives the EPG containing the service/contents information and the CUI and processes the EPG to render the content. The renderer 401 extracts the CUI from the EPG and transfers the extracted CUI to a controller 400. A CUI storage 410 stores the CUI information (or CUI page) extracted from the EPG by the renderer 401. The controller 400 checks the CUI information stored in the CUI storage 410 and displays the CUI to the user on the screen. The user can control the playback of the service/contents rendered by the renderer 401 by means of the CUI. The user can control the playback of the service/contents on the display (not shown) using the CUI configured by the controller 400.

The renderer 401, the CUI storage 410, the controller 400, and the display (not shown) are the function blocks of the user device, i.e., the digital television receiver or a mobile device (e.g., mobile phone), capable of receiving and playing the broadcast service.

In the above structured broadcast system, the service/content provider 402 creates and provides the service/contents. The service/contents can include real time broadcast content and various types of data. The EPG generator 411 generates CUIs corresponding to the type of the service/contents provided by the service/content provider and inserts the CUIs into the EPG information. The service/contents information and the EPG information are delivered to the user devices. Specifically, the service/content transmitter generates the EPG containing the CUIs corresponding to the respective service/contents and transmits the EPG to the user device.

If the EPG has been received, the renderer 401 of the receiver separates the CUI information from the EPG information. The renderer 401 transfers the CUI of the currently playing service/contents to the controller 400. The controller 400 is responsible for processing the service/contents and the EPG corresponding to the service/contents rendered by the renderer 401. The controller 400 stores the CUI information separated from the EPG information within the CUI storage 410 and processes the CUI corresponding to a currently selected service/contents. Specifically, the controller 400 controls the playback of the content according to the user command input by means of the CUI provided by the renderer 401. The CUI is displayed on a display in the form of a control screen. Accordingly, the user can control the playback of the ongoing service/contents by means of the content-specific CUI.

When the renderer 401 has a function for rendering a CUI page and the content, it can provide the CUI information, in the form of the CUI page, to the controller 400.

FIG. 5 is a diagram illustrating a digital broadcast system for delivering content-specific CUI, according to another embodiment of the present invention. In the embodiment of FIG. 5, the controller 400 is integrated in the renderer 401.

Referring to FIG. 5, the renderer 401 renders the service/contents and EPG received from the transmitter and separates the CUI from the EPG. The renderer 401 processes the CUI information corresponding to the ongoing service/contents and displays the content-specific CUI on the display in the form of a control screen. The function blocks of FIG. 5 operate in the same manner as those of FIG. 4.

The receiver of the digital broadcast system structured as shown in FIG. 4 or FIG. 5 can be a display device, or a mobile device having a display, for displaying the CUI in the form of a control screen without a dedicated remote controller. Typically, a fixed device such as a digital television (TV) is provided with a relatively large display such that it is possible for the user to control the playback of the service/contents with a large control menu screen using a dedicated remote controller. However, the mobile device has a display that is limited in size to display the control UI screen. In an embodiment of the present invention, the mobile device separates the CUI from the EPG and configures a control screen efficiently in order for the user to control the ongoing service/contents easily. When the display supports the touchscreen function, the CUI can be configured for the user to control the playback of the content more effectively.

The transmitter of the digital broadcast system structured as shown in FIG. 4 or FIG. 5 provides the service/contents and EPG including the content-specific CUI information. The CUI information is provided for the user device to present a CUI dedicated to the type of the corresponding service/contents. The service/contents and EPG can be transmitted simultaneously or separately. The CUI is service/contents specific. For example, the CUI for the real time broadcast service/contents is composed of the alphanumeric character input interface, and the CUI for the CoD content is composed of a playback control interface having a plurality of buttons, as shown in FIG. 2.

The receiver renders the received service/contents and EPG. The renderer 401 separates the CUI from the EPG and stores the CUI in the CUI storage 410 such that, when the user selects a specific service/contents, the receiver reads the CUI corresponding to the selected service/contents to display on the display unit (not shown). The CUI displayed on the display unit can be a graphic User Interface (UI) including graphical input buttons for inputting commands related to the playback of the corresponding service/contents. The user can input a command by using the CUI displayed on the display unit for manipulating the playback of the service/contents.

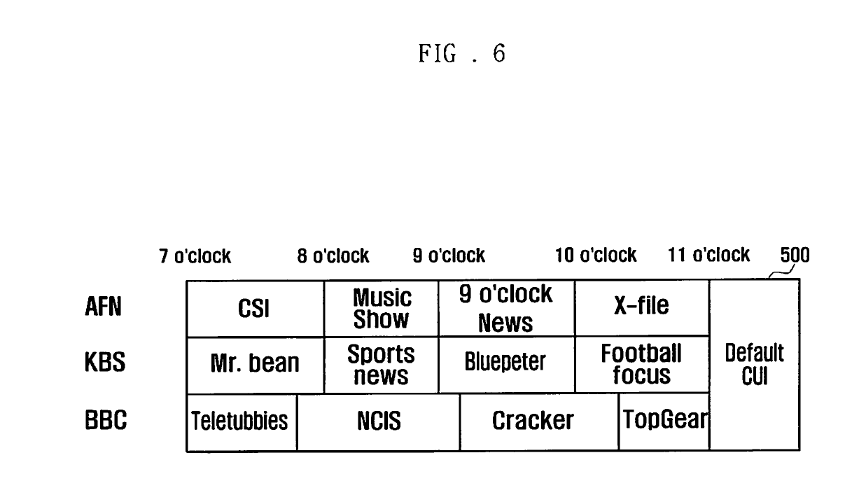

FIG. 6 is a diagram illustrating a CUI delivered in an EPG for use in a digital broadcast system, according to an embodiment of the present invention.

Referring to FIG. 6, the EPG includes metadata for a default CUI 500 in addition to basic information such as channels, programs of the channels, and air times of the programs. The default CUI 500 is a basic UI for controlling all types of programs arranged in the EPG.

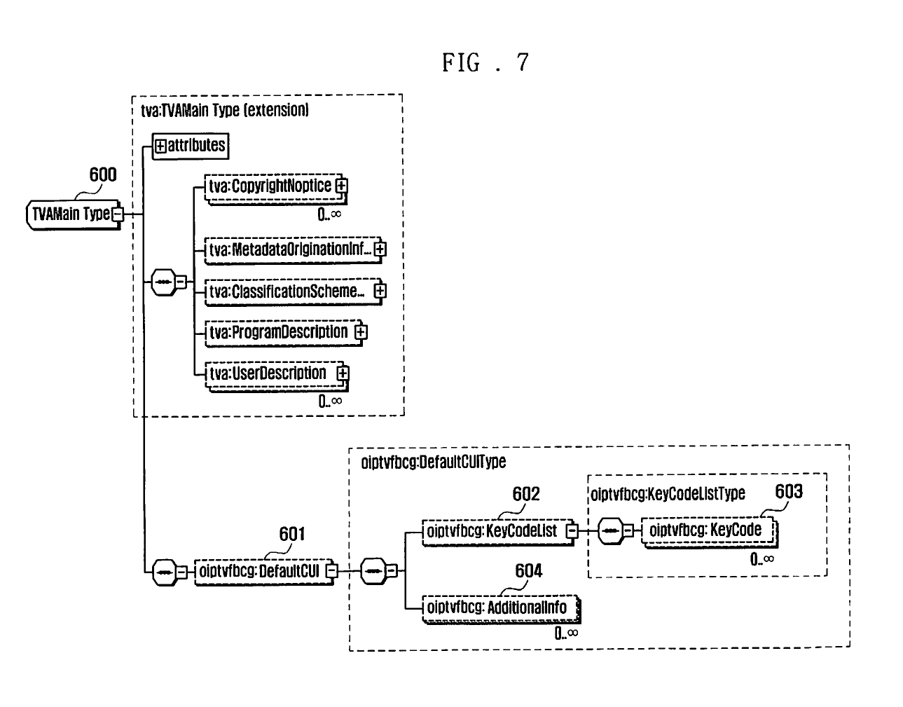

FIG. 7 is a diagram illustrating a metadata type structure for carrying the EPG and CUI of FIG. 6, according to an embodiment of the present invention. FIG. 7 shows metadata structured based on the TV-AnyTime specifications.

Referring to FIG. 7, a DefaultCUI element 601 is located under a TVAMainType element 600. The location of the DefaultCUI element 601 can be changed. The DefaultCUI element 601 has a KeyCodeList element 602 aggregating the control keys and an AdditionalInfo element 604 for the service/contents provider to provide additional information. The service/contents provider 402 can provide an advertisement URL and undefined control action values to the renderer 401, which is responsible for processing the EPG and rendering the contents, by means of the AdditionalInfo element 604. The user can perform enhanced control actions using the AdditionalInfo element 604 provided by the service/contents provider 402. The KeyCodeList element 602 has KeyCode elements 603 for individual controls.

In FIG. 7, the KeyCode elements 603 can have predetermined KeyCode values, as shown in Table 1. The KeyCodes can be set to individual values, as shown in Table 1 or aggregated into a group with a single value, as shown in Table 2. FIG. 12 shows a navigation keys group aggregating five individual keys as a KeyCode group.

TABLE 1

REWIND = 412:
STOP = 413:
EJECT_TOGGLE = 414:
PLAY = 415:
RECORD = 416:
FAST_FWD = 417:
PLAY_SPEED_UP = 418:
PLAY_SPEED_DOWN = 419:
PLAY_SPEED_RESET = 420:

.
.
.

TABLE 2

<navigationkeys> true </navigationkeys>
<numerickeys> true </numerickeys>
<colorkeys> false </colorkeys>
<playcontrolkeys> true </playcontrolkeys>

.
.
.

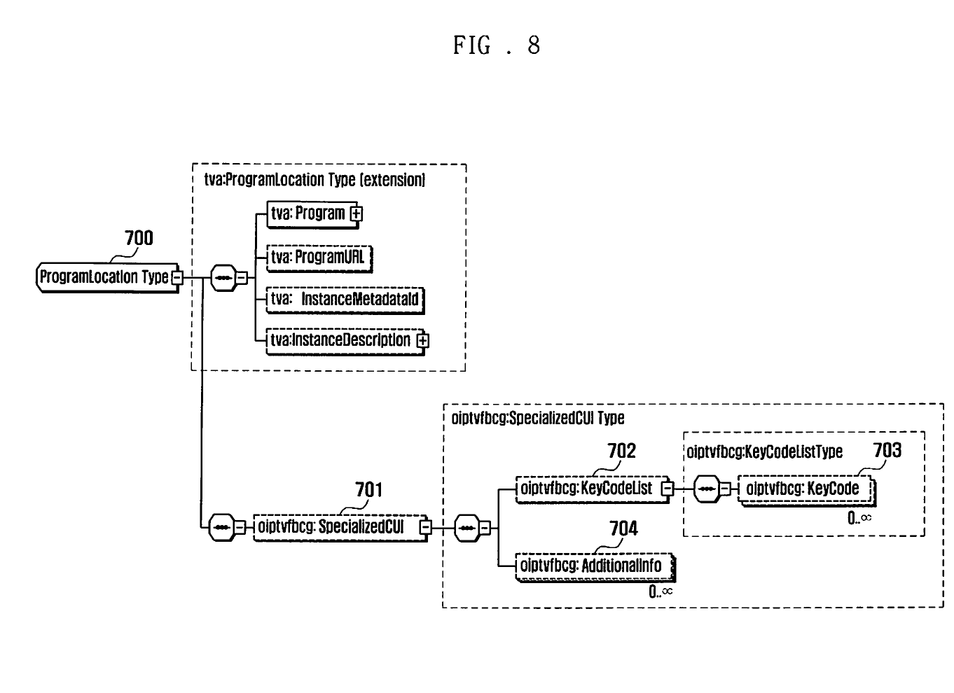

FIG. 8 is a diagram illustrating a structure of metadata for providing a content-specific CUI, according to an embodiment of the present invention.

As shown in FIG. 8, a SpecializedCUI element 701 is located under a ProgramLocationType element 700 of the metadata. The ProgramLocationType element 700 contains basic information about programs, i.e. the contents. The location of the SpecializedCUI element 701 can be changed. The SpecializedCUI element 701 has content-specific CUIs corresponding to individual content. The content-specific CUI can be expressed with a KeyCodeList element 702 and an AdditionalInfo element 704. The KeyCodeList element 702 is a group of control action keys available for controlling corresponding content, i.e., a set of KeyCode elements 703. The KeyCode elements 703 can be set to individual values, as shown in Table 1, or aggregated with a group value, as shown in Table 2.

As described with reference to FIG. 7, an AdditionalInfo element 704 contains additional information elements other than the control actions defined by the service/content provider 402 and differs from the Additional element 604 in that it can provide additional information about the current content. For example, if a drama “friends” is ongoing, the AdditionalInfo element 704 can provide supplementary information about clothes worn by actors and actresses and handheld devices used by them, along with links to shopping mall selling those items.

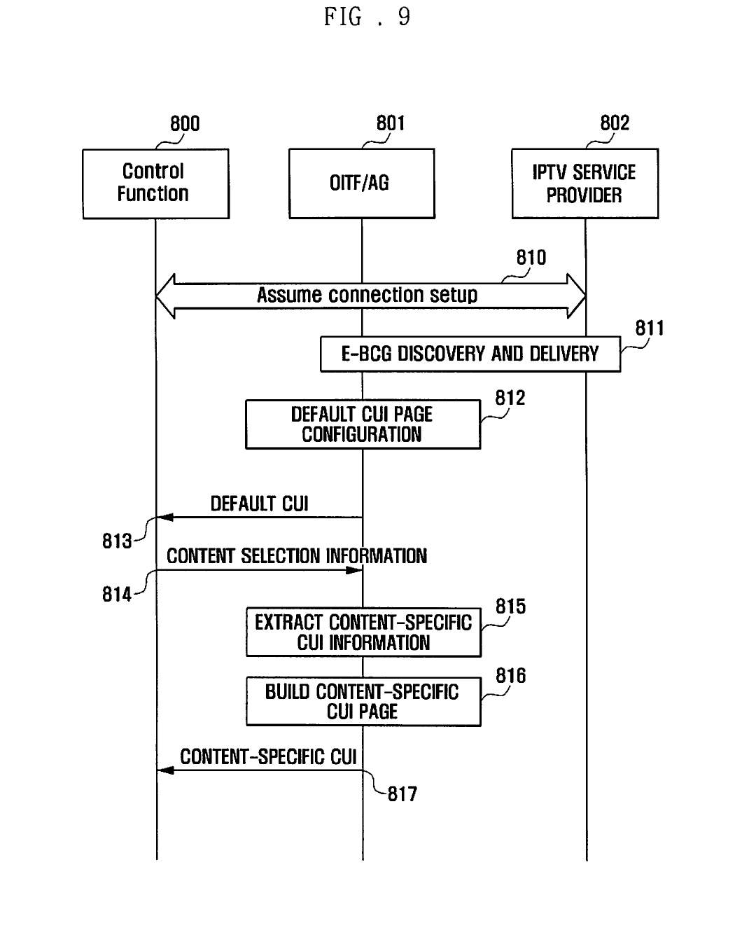

FIG. 9 is a sequence diagram illustrating operations of a controller, an OITF device, and an IPTV service provider constituting a digital broadcast system for supporting the CUI delivery method, according to an embodiment of the present invention.

Referring to FIG. 9, a control function 800 is a logical entity for a user to control a TV or a set-top box. An OITF/AG 801 is a logical entity included in the TV or the set-top box that operates under the control of the control function 800. The OITF/AG 801 is responsible for parsing the EPG data and CUI information and rendering the content. An IPTV service provider 802 creates the content, EPG data and CUI information included in the EPG data. The control function 800 corresponds to the controller 400 and CUI storage 410 of FIGS. 4 and 5, the OITF/AG 801 corresponds to the renderer 401 of FIGS. 4 and 5, and the IPTV service provider 802 corresponds to the service/content provider 402 and information generator 411 of FIGS. 4 and 5.

It is assumed herein that a connection is established among the control function 800, the OITF/AG 801, and the IPTV service provider 802 before the information generated by the IPTV service provider 802 is transmitted to the OITF/AG 801 and the control function 800. Specifically, the control function 800, the OITF/AG 801, and the IPTV service provider 802 are linked through a connection setup process in step 810. The OITF/AG 801 performs an E-BCG discovery for acquiring the EPG information transmitted by the IPTV service provider 802 in step 811. The IPTV service provider 802 transmits the E-BCG to the OITF/AG 801, and thus, the OITF/AG 801 received the E-BCG transmitted by the IPTV service provider 802. BCG corresponds to the EPG, and Enhanced indicates that the BCG contains the CUI information.

The OITF/AG 801 receives the EPG information from the IPTV service provider 802, forms a Default CUI Page based on CUI information extracted from the EPG information, and displays the Default CUI page on the screen in step 812. The OITF/AG 801 transmits the configure UI or only the information required for building the UI to the control function 800 such that the control function 800 configures the Default CUI page based on the UI information. A description is provided in which the OITF/AG 801 generates the Default CUI Page based on the Default CUI information and transmits the Default CUI Page to the control function 800 in step 813. The control function 800 renders and displays the Default CUI page to the user in the form of an EPG screen. If content is selected from the EPG, the control function 800 transmits information on the selected content to the OITF/AG 801 in step 814.

The OITF/AG 801 renders the content and performs parsing on the EPG metadata to extract the content-type specific CUI information corresponding to the selected content in step 815. The OITF/AG 801 configures the content-specific CUI page corresponding to the ongoing content based on the extracted information in step 816. Once the CUI page has been created, the OITF/AG 801 transmits the CUI page to the control function 800 in step 817, such that the user can control the content rendered currently by the OITF/AG 801 on the CUI page.

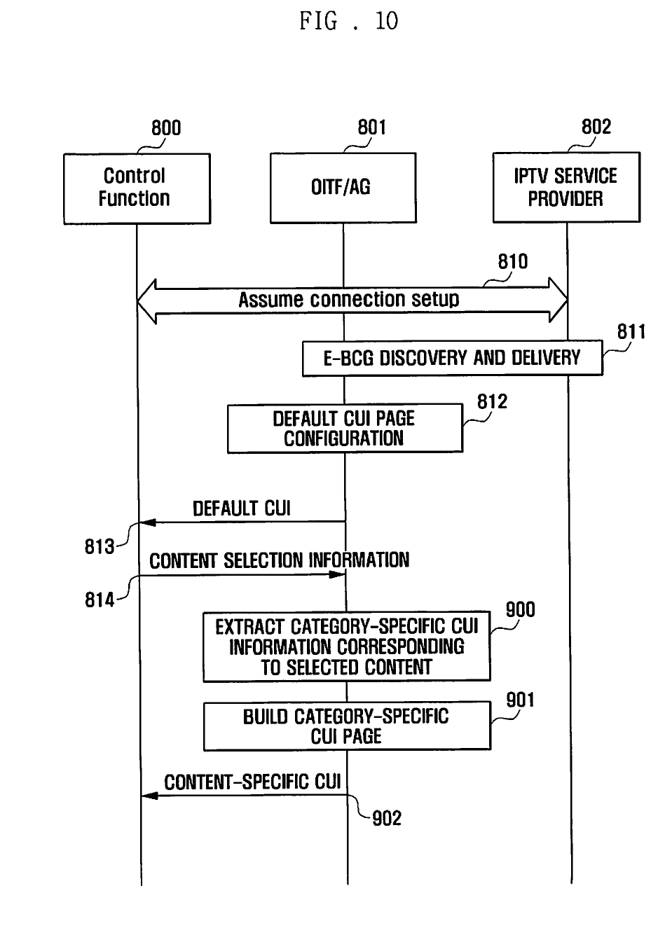

FIG. 10 is a sequence diagram illustrating operations of a controller, an OITF/AG, and an IPTV service provider constituting a digital broadcast system for supporting the CUI delivery method, according to another embodiment of the present invention. In the embodiment of FIG. 9, the content is categorized by type and category-specific CUIs are provided along with the individual content.

The embodiment of FIG. 10 is identical to that of FIG. 9 in steps 810 to 813. If the Default CUI has been received at step 813, the control function 800 displays the CUI on the screen such that the user can select content from the EPG by means of the CUI. If a user selection has been detected, the control function 800 sends the information on the selected content to the OITF/AG 801 in step 814. If the selected content information has been received, the OITF/AG 801 extracts category CUI information of the selected content information in step 900. The content can be categorized by type (e.g., CoD, Linear TV (real time broadcast), communication service as described in FIG. 1) or by content provider (e.g. MBC, KBS, and MTV). The OITF/AG 801 builds a category-specific CUI page in step 901 and transmits the category-specific CUI page to the control function 800 in step 902.

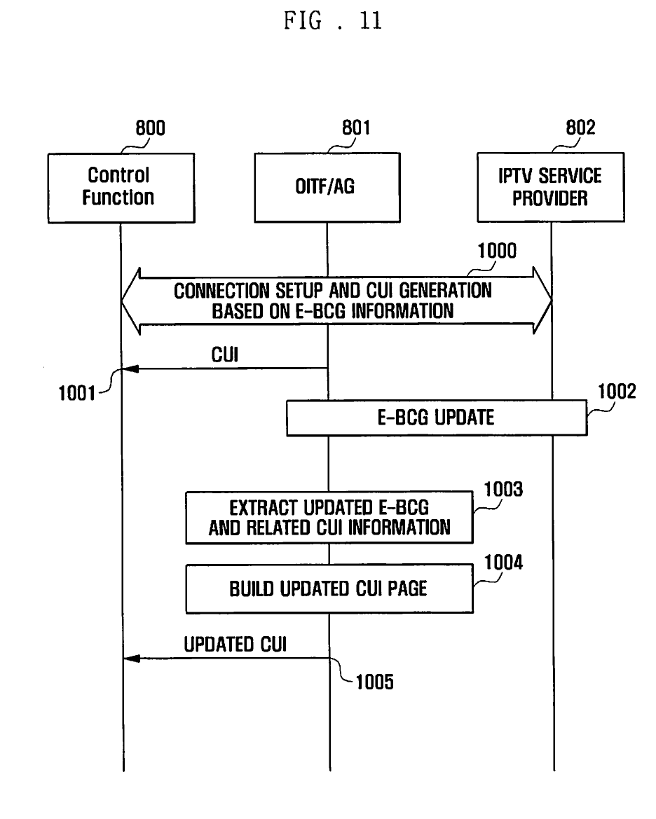

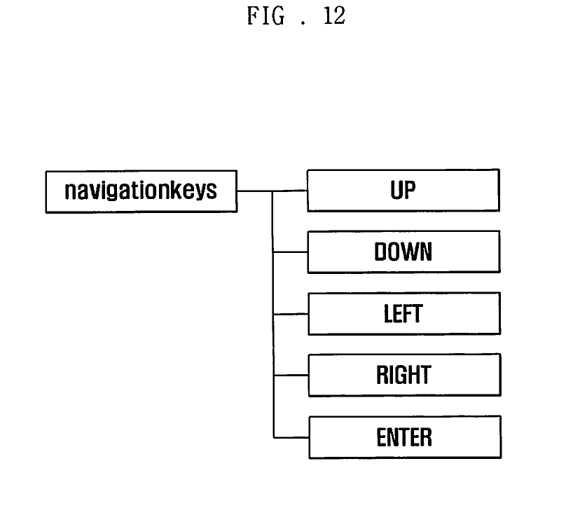

FIG. 11 is a sequence diagram illustrating operations a controller, an OITF/AG, and an IPTV service provider constituting a digital broadcast system when the E-BCG metadata is updated while consuming content, according to an embodiment of the present invention.

In FIG. 11, it is assumed that the connection setup is established among the control function 800, the OITF/AG 801, and the IPTV service provider 802 in step 1000, and the CUI generated based on the E-BCG information is delivered to the control function 800 in step 1001 such that the user is controlling the ongoing playback of the content rendered by the OITF/AG 801 by means of the CUI page. In this state, the OITF/AG 801 receives an updated E-BCG transmitted by the IPTV service provider 802 in step 1002. If the updated E-BCG has been received, the OITF/AG 801 analyzes the updated E-BCG information and extracts the CUI information from the E-BCG information in step 1003. The OITF/AG 801 builds an updated CUI page using the CUI information in step 1004 and then transmits the updated CUI page to the control function 800 in step 1005. As a consequence, the user can control the playback of the ongoing content by means of the updated CUI page.

As described above, the CUI delivery method of the present invention enables a user device to build a content-specific CUI based on the content-specific CUI information transmitted by the service/content provider and display the content-specific CUI along with the corresponding content. The user can control the playback of the content by means of the content-specific CUI. The CUI delivery method of the present invention is capable of providing the user with the different CUIs optimized for the individual content or type of content, thereby facilitating playback controls of various types of content.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A transmission apparatus for a digital broadcast system, comprising:
a provider that provides one or more of contents;
an information generator that generates Electronic Program Guide (EPG) information including Control User Interface (CUI) information; and
a transmitter that transmits the EPG information and the one or more of the contents,
wherein the CUI information is provided per contents.

2. The transmission apparatus of claim 1, wherein the CUI information comprises a plurality of key codes for controlling use of the one or more of the contents.

3. The transmission apparatus of claim 2, wherein the EPG comprises program items representing the one or more of the contents and linked to corresponding CUIs.

4. A reception apparatus for a digital broadcast system, comprising:
a receiver that receives one or more of contents and Electronic Program Guide (EPG) information including Control User Interface (CUI) information;
a renderer that renders an EPG and the one or more of the contents and builds a CUI of a selected contents based on the CUI information extracted from the EPG information; and
a controller that controls display of the CUI of the selected contents and playback of the selected contents in response to a command input via the CUI.

5. The reception apparatus of claim 4, wherein the renderer separates the CUI information from the EPG information and transmits the CUI corresponding to the selected contents to the controller, and wherein the CUI comprises a plurality of key codes for controlling the selected contents.

6. The reception apparatus of claim 5, wherein the renderer extracts the CUI information corresponding to the selected contents selected by the controller, builds a CUI page based on the CUI information, and transmits the CUI page to the controller.

7. The reception apparatus of claim 5, wherein the renderer extracts the CUI information corresponding to the selected contents selected by the controller, and the controller builds a CUI page based on the CUI information and displays the CUI page on a screen.

8. A contents delivery method for a digital broadcast system, comprising the steps of:
generating, at a transmitter, Control User Interface (CUI) information for controlling consumption of one or more of contents;
generating Electric Program Guide (EPG) information including items representing the one or more of the contents and the CUI information; and
transmitting the EPG information and the one or more of the contents,
wherein the CUI information is provided per contents.

9. The contents delivery method of claim 8, wherein the CUI information comprises a plurality of key codes for controlling use of the one or more of the contents.

10. The contents delivery method of claim 9, wherein the EPG information comprises program items representing the one or more of the contents and linked to corresponding CUIs.

11. The contents delivery method of claim 8, further comprising:
receiving, at a receiver, the one or more of the contents and the EPG information including the CUI information;
rendering the one or more of the contents and the EPG;
configuring a CUI corresponding to a selected contents based on the CUI information;
displaying the CUI on a screen; and
executing a command input through the CUI.

12. The contents delivery method of claim 11, wherein displaying the CUI comprises:
separating the CUI information from the EPG information; and
presenting the CUI corresponding to the selected contents on the screen based on the CUI information,
wherein the CUI includes a plurality of key codes for controlling the selected contents.

13. The contents delivery method of claim 11, wherein displaying the CUI comprises:
extracting the CUI information corresponding to the selected contents; and
presenting the CUI corresponding to the selected contents on the screen in the form of a CUI page.
